(19) United States
(12) Patent Application Publication
(10) Pub. No.: US 2018/0045183 A1
(43) Pub. Date: Feb. 15, 2018

(54) Electricity Generator Powered By Air Exhaust

(71) Applicant: Cheng-Ta Ho, Kaohsiung City (TW)

(72) Inventor: Cheng-Ta Ho, Kaohsiung City (TW)

(21) Appl. No.: 15/233,996

(22) Filed: Aug. 11, 2016

(51) Int. Cl. F03D 9/00; F03D 9/25

(52) U.S. Cl. CPC F03D 9/002; F03D 9/25

(57) ABSTRACT

An electricity generator is mounted on an air exhaust port of a cooling tower and contains a delivery pipe and a wind turbine. The delivery pipe includes an air inlet and an air outlet opposite to the air inlet, and the air inlet corresponds to the air exhaust port of the cooling tower. The wind turbine includes a power generation device and a propeller rotatably connected with the power generation device and housed between the air inlet and the air outlet of the delivery pipe. Preferably, the delivery pipe is connected with the air exhaust port so that when the cooling tower operates, hot air exhausts from the air outlet via the air inlet.

### FIELD OF THE INVENTION

The present invention relates to an electricity generator which is powered by air exhaust from a cooling tower so as to generate electricity stably.

### BACKGROUND OF THE INVENTION

A conventional wind turbine generates mechanical energy by way of wind power and converts the mechanical energy into electric energy of an electricity generator. However, natural wind power cannot produce and be recycled stably.

As illustrated in FIG. 4, a conventional cooling tower 80 contains an air exhaust port 81 arranged on a top thereof, a motor 82 fixed on the air exhaust port 81, and an exhaust fan 83 rotatably connected with the motor 82, wherein the exhaust fan 83 exhausts hot air from the cooling tower 80 at a fixed wind speed. However, air exhaust of the cooling tower 80 cannot be recyclable efficiently.

The present invention has arisen to mitigate and/or obviate the afore-described disadvantages.

### SUMMARY OF THE INVENTION

The primary objective of the present invention is to provide an electricity generator which is powered by air exhaust from a cooling tower so as to generate electricity stably.

To obtain above-mentioned objective, an electricity generator provided by the present invention is mounted on an air exhaust port of a cooling tower and contains a delivery pipe and a wind turbine.

The delivery pipe includes an air inlet and an air outlet opposite to the air inlet, and the air inlet corresponds to the air exhaust port of the cooling tower.

The wind turbine includes a power generation device and a propeller rotatably connected with the power generation device and housed between the air inlet and the air outlet of the delivery pipe.

Preferably, the delivery pipe is connected with the air exhaust port so that when the cooling tower operates, hot air exhausts from the air outlet via the air inlet.

### BRIEF DESCRIPTION OF THE DRAWINGS

FIG. 1 is a perspective view showing the assembly of an electricity generator according to a preferred embodiment of the present invention.

FIG. 2 is a cross sectional view showing the operation of the electricity generator according to the preferred embodiment of the present invention.

FIG. 3 is another cross sectional view showing the operation of the electricity generator according to the preferred embodiment of the present invention.

FIG. 4 is a side plan view of a conventional cooling tower.

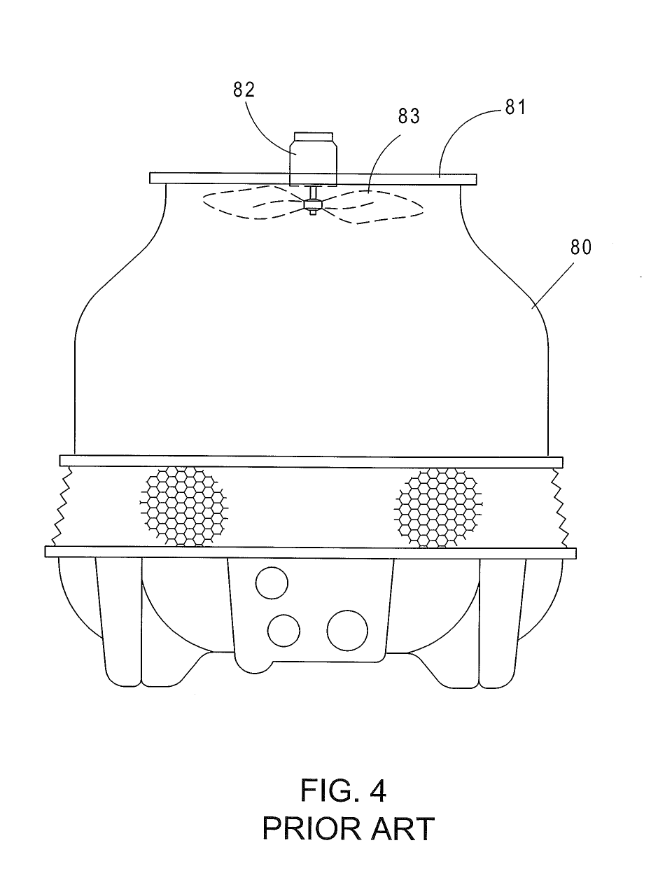

### DETAILED DESCRIPTION OF THE PREFERRED EMBODIMENTS

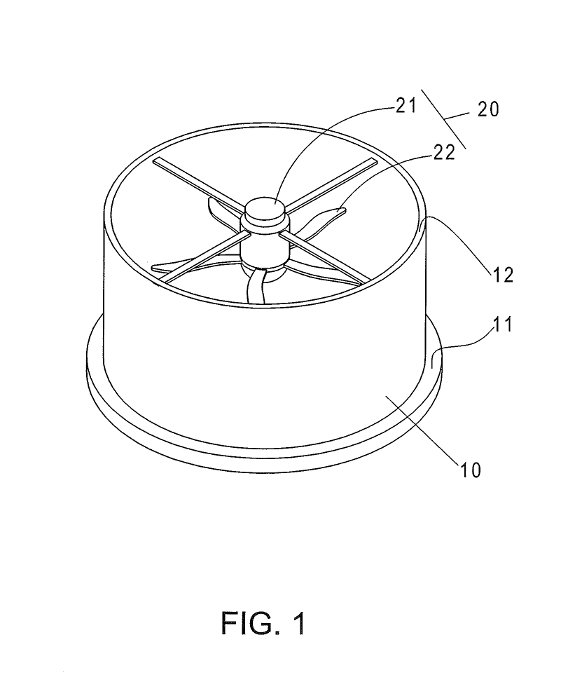

Referring to FIG. 1, an electricity generator according to a preferred embodiment of the present invention comprises: a delivery pipe 10 and a wind turbine 20, and the electricity generator is mounted on an air exhaust port of a cooling tower so as to extract heat from exhaust air of the cooling tower.

The delivery pipe 10 includes an air inlet 11 and an air outlet 12 opposite to the air inlet 11, and the air inlet 11 corresponds to the air exhaust port 81 of the cooling tower 80, wherein the delivery pipe 10 is connected with the air exhaust port 81 so that when the cooling tower 80 operates, hot air exhausts from the air outlet 12 via the air inlet 11.

The wind turbine 20 includes a power generation device 21 and a propeller 22 rotatably connected with the power generation device 21 and housed between the air inlet 11 and the air outlet 12 of the delivery pipe 10.

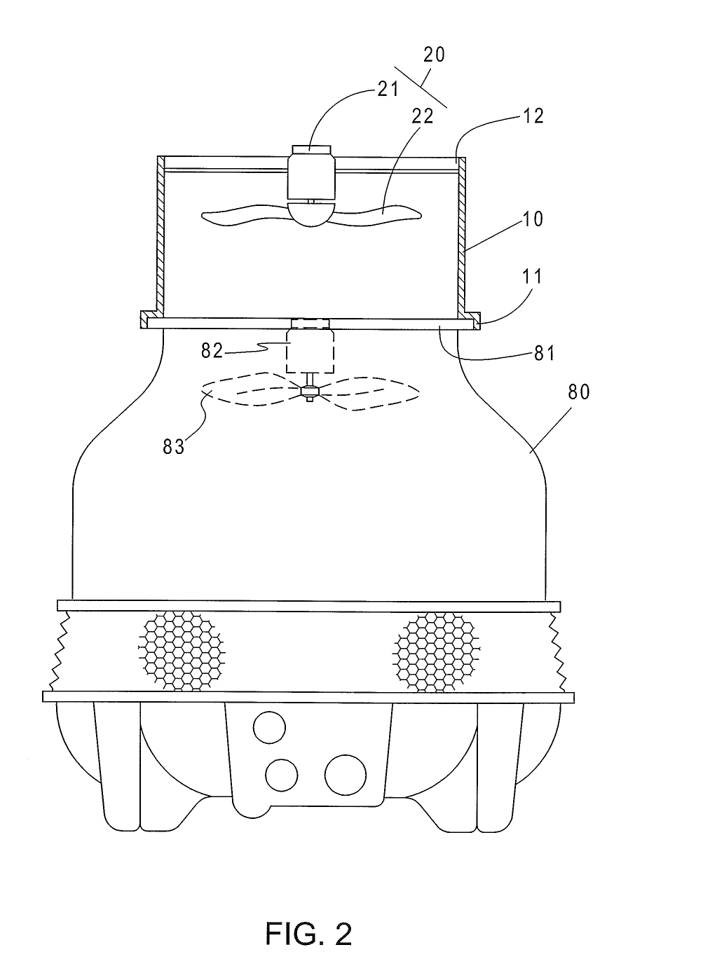

As shown in FIG. 2, when the cooling tower 80 operates, the hot air flows through the delivery pipe 10 of the electricity generator, and the propeller 22 is pushed by the hot air to revolve, such that the power generation device 21 is actuated by the propeller 22 to generate electricity, after mechanical energy of the power generation device 21 transformers into electric energy.

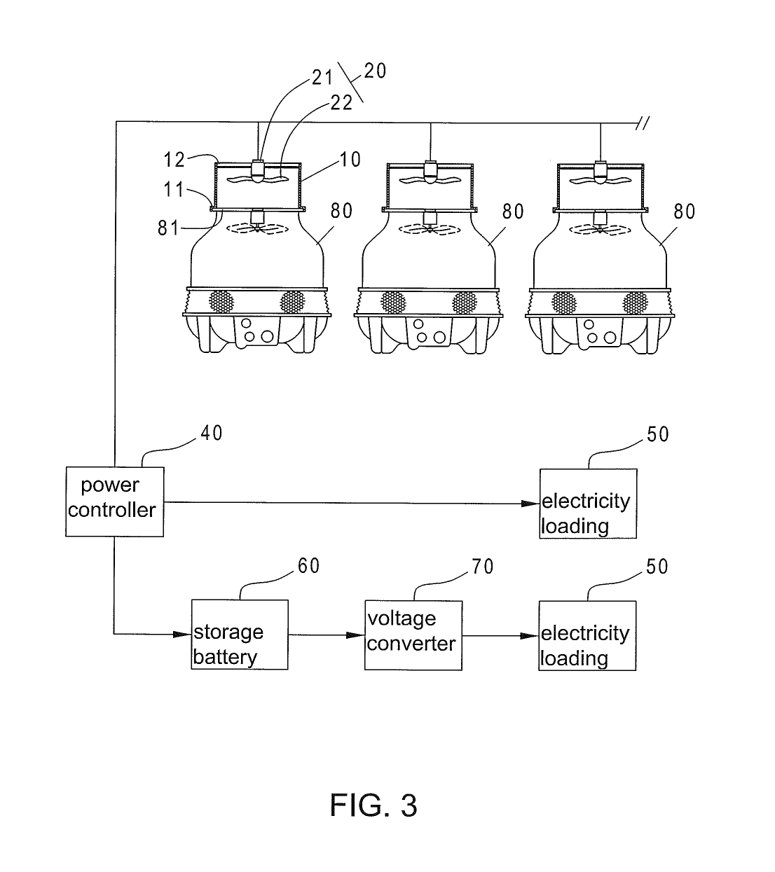

Referring further to FIG. 3, multiple electricity generators are mounted on a plurality of cooling towers 80, respectively, wherein a plurality of wind turbines 20 of the multiple electricity generators are parallelly connected together so that electricity generating from the plurality of wind turbines 20 gathers to a power controller 40 which supplies the electricity to an electricity loading 50 configured to supply the electricity to illumination equipment. Alternatively, the power controller 40 supplies the electricity to at least one storage battery 60 configured to store the electricity, wherein the at least one storage battery 60 is coupled with a voltage converter 70 configured to convert the electricity at a predetermined voltage, thus supplying the electricity to the electricity loading 50.

Accordingly, the electricity generator of the present invention is powered by the air exhaust from the cooling tower so as to generate the electricity stably. For example, it is assumed that the electricity generator generates the electricity of 400 W/per hour and the cooling tower operates every day, so the electricity generator of the present invention generates electricity of 3,456 kWh (i.e., 400 W×24 hrs×360 days). Preferably, the delivery pipe 10 reduces noises from a motor and loss of cooling water in the cooling tower.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. An electricity generator mounted on an air exhaust port of a cooling tower and comprising:
a delivery pipe including an air inlet and an air outlet opposite to the air inlet, and the air inlet corresponding to the air exhaust port of the cooling tower; and
a wind turbine including a power generation device and a propeller rotatably connected with the power generation device and housed between the air inlet and the air outlet of the delivery pipe;
wherein the delivery pipe is connected with the air exhaust port so that when the cooling tower operates, hot air exhausts from the air outlet via the air inlet.
